(19) United States
(12) Patent Application Publication
(10) Pub. No.: US 2014/0156439 A1
(43) Pub. Date: Jun. 5, 2014

(54) Method and Process of Conducting On Demand Electronic Auction

(71) Applicant: Donald Foy, Atlanta, GA (US)

(72) Inventor: Donald Foy, Atlanta, GA (US)

(21) Appl. No.: 13/826,027

(22) Filed: Mar. 14, 2013

Related U.S. Application Data
(60) Provisional application No. 61/732,545, filed on Dec. 3, 2012.

(51) Int. Cl. G06Q 30/08

(52) U.S. Cl. CPC G06Q 30/08
USPC 705/26.3

(57) ABSTRACT

A method and process of conducting a buyer driven, on demand, electronic auction for products, such as automobiles. The method and process includes an auction central processing unit connected to multiple user interfaces. A product qualification, inventory qualification, backend administration, product data, scheduler and bidder modules are also included. An auction is conducted wherein the products presented in the set auction are driven by buyer demand, may be instituted upon determination of a predetermined level of interest, and products may simultaneously be bid upon.

### FIELD OF THE INVENTION

The present invention is directed to a method of producing an electronic, on demand marketplace, such as an auction, for products, such as automobiles, wherein product demand is driven by the buyers and a method of conducting the electronic, on demand auction.

### BACKGROUND OF THE INVENTION

Conventional wholesale automobile auctions are conducted in prescribed physical locations wherein the inventory is transported to the physical location and offered for sale at an auction at a prescribed date and time. The dealer or buyer is physically present for the auction and considers the inventory in order of presentation. That is, the auction continues in a linear manner wherein each car is presented for auction in succession, one automobile after another.

The drawbacks of a successive auction are many. For example, if two hundred products, such as automobiles, are presented at a physical auction, the dealer/buyer must await the presentation of each automobile he or she is interested in for bidding. If the buyer is interested in car number, say, one-hundred-ninety-nine, the buyer must wait for the bidding on that item to begin. If the buyer intends to purchase a single product, and if the buyer is unsuccessful in winning the bidding for an acceptable price, the buyer is precluded from participating in auctions for other automobiles, such as a second or third choice, because those auctions have closed. There is no process to facilitate the buyers' preferences among multiple automobiles since the automobiles are presented in succession rather than simultaneously. The cars offered in a conventional auction represent the available inventory, they do not necessarily represent inventory controlled by buyers' demand or interest.

The seller, inherently, incurs expenses associated with transporting the automobile, insuring the automobile, and the costs associated with carrying the automobile on its books awaiting the next scheduled sale and for the time the automobile is transported. The seller also incurs costs associated with the party conducting the physical auction such as storage, insurance, and overhead of the auction house and auctioneer. The buyer or dealer incurs the cost of attending the auction and waiting for items of interest to be presented in succession. The buyer also bears the risk of not obtaining the optimal price on an automobile or an optimal inventory of automobiles successfully purchased. Moreover, that inventory is generally limited by the amount of time the dealers that attend the event have to view and bid on the inventory.

The Internet provides means for electronic commerce by enabling online auctions. A conventional online auction (such as eBay, for example) announces a product to be auctioned at a particular date and time and with a predetermined end time. Such auctions typically have a minimum bid required and prescribed incremental increases and incorporate proxy bidding. They may also provide a “buy now” price. These auctions provide multiple online marketplaces, each auction for a single item. In that regard, conventional auctions are unilateral or autonomous, meaning that the bidding on one item does not impact the bidders bidding on other items. Stated differently, each bidding process for each product is independent.

Currently, the seller's only alternatives are to set vehicles for sale in a competitive bid environment are a conventional online auction or “in-lane” (that is, a physical sale), on a certain date and for a duration. The seller then has to market the inventory being sold and the information pertaining to the sale.

In the field of automobile auctions, a related process has been employed wherein a digital auction is created to sell an inventory of automobiles. These auctions proceed in a similar fashion as physical auction sites wherein the inventory is auctioned digitally one at a time. Variations to this basic model exist which enhance the auction experience and outcomes. For example, U.S. Pat. No. 8,296,191 (the “191 patent”) is directed to an electronic open-market sale which obviates the need for a buyer/bidder to access numerous websites to compare prices or participate in separate autonomous auctions. According to the invention of '191 patent, the bidder/buyer may present parameters for a desired purchase and multiple sellers may tender an offer to the bidder/buyer possessing a certain profile. The various tenders are then presented to the bidder/buyer. U.S. Pat. No. 8,251,701 (the “'701 patent”) is directed to a method for conducting an online auction wherein the bidder/buyers are attributed with one or more predefined qualities associated with a particular product. The system, according to '701 patent, then defines or partitions a subset or pool of bidder/buyers and the pool is presented to potential customers.

And U.S. Pat. No. 8,171,022 is directed to an electronic auction incorporating conjoint analysis to facilitate user interaction with a search engine. The method determines the relative importance of relevant attributes to avoid rendering a complex list of alternatives in an auction. Instead, a shortened, personalized list of alternatives is presented to the user. These prior art methods, while successfully achieving their stated purposes, do not purport to address objectives of the method according to the present application. That is, they do not create buyer driven, on demand, electronic auctions which enable simultaneous bidding on multiple products once threshold levels of demand are identified.

### SUMMARY OF THE INVENTION

In accordance with preferred embodiments of the present invention, the present invention obviates shortcomings of the prior art by providing a method of a buyer demand-driven auction which is presented on demand and enables buyers to simultaneously bid on multiple products. The method according to the present invention offers all inventory to all potential buyers and allows those buyers to determine which products are presented in the online auction in which they have, at least in part, created. It also enables simultaneous bidding by buyers of products in which they have expressed actual interest. Moreover, products sold according to the present invention may simultaneously be progressing toward a conventional sales process, such as a physical auction, while the method of the present invention is on-going. Thus, if the product is sold according to the present invention prior to the conventional method, it may avoid the costs associated with conventional auctions and be re-routed.

More specifically, this is achieved according to the method and process of the present invention by providing a network, user interface (such as a personal computer), auction central processing unit, sale process module, backend administration module, product data module, product qualification module, inventory qualification module, scheduler module and bidder module. The product qualification module receives data from the auction processing unit to determine whether a predetermined minimum number of bidders are present to qualify the product. The system, through the inventory qualification module and the central processing unit, determines whether a predetermined minimum number of qualified products are met to set a qualified inventory. The minimum number of products and inventory are configurable and defined in the backend administration module. The scheduler module then utilizes this date to schedule the auction, run simultaneous jobs to set, monitor, notify and schedule the auction. The sales process module and bidder module then conduct the buyer driven, electronic, on demand auction.

The benefits of this method are numerous. From a buyer's perspective, the buyer participates, electronically, in an auction the buyer created; that is, the inventory of the auction includes vehicles he has expressed interest in. In that regard, the list presented in the electronic auction is limited to products in which the buyer, and other buyers, has expressed interest. Moreover, the buyer may simultaneously bid on multiple products at the same time, at the same online location, and have more control over the outcome of products in the auction. From a seller's perspective, auctions are created upon evidence of buyer demand, meaning that they may be instituted and conducted very quickly, especially for popular products. The costs associated with carrying a product to a conventional “in-lane” sale or awaiting the next scheduled electronic auction are obviated when a sale according to the present invention results.

The system described herein is capable of handling an inventory of hundreds, thousands or more of products, such as automobiles, in a variety of remote locations, for auction in multiple time zones, and presented to hundreds, thousands, or more potential bidders. And this can be effectuated with a system and method that is configurable to accommodate peak auction time windows. These and other advantages are achieved according to the method and system of the present invention.

### BRIEF DESCRIPTION OF THE DRAWINGS

FIG. 1 is a schematic overview of a buyer driven, on demand auction in accordance with various aspects of the present invention;

FIG. 2 is a schematic overview of the product qualification module;

FIG. 3 is a schematic overview of the auction qualification module;

FIG. 4 is a process flowchart of the sales process;

FIG. 5 is a process flowchart of the schedule module;

FIG. 6 is a screen shot of the product data module display;

FIG. 7 is an image of a user screen logged onto a sale; and

FIG. 8 is an image or user login page.

### DETAILED DESCRIPTION OF THE INVENTION

The present invention will now be described in detail hereinafter by reference to the accompanying drawings. The invention is not intended to be limited to the embodiments described; rather, this detailed description is provided to enable any person skilled in the art to make and practice. The method and process described herein may be utilized in connection with numerous products and the discussion which follows pertain to use in connection with the sale of automobiles. It is to be understood, however, that the method and system may be utilized to sell any product, tangible or intangible (for example, financial instruments, insurance policies, etc.).

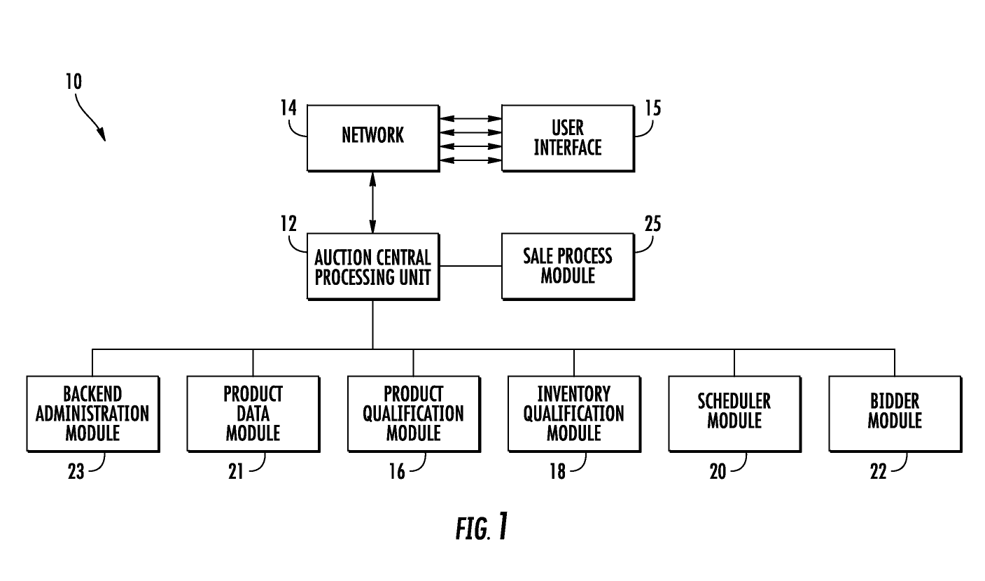

With reference to FIG. 1, an exemplary system 10 for implementing the subject matter described herein includes an auction central processing 12 unit configured to communicate with one or more bidder systems through a suitable network 14 (e.g., the Internet, an intranet, an extranet, or the like). The bidder system includes a user interface 15 in the form of a general purpose computing device such as a conventional personal computer, including a processing unit, a system memory, and a system bus that couples various system components including the system memory to the processing unit. The user interface 15 and the auction central processing unit 12 may couple to the network 14 through any convenient network access device and connection. For example, analog modems, cable modems, xDSL interfaces, T1 lines, wireless connections and the like.

FIG. 1 represents a schematic overview of an online, on demand marketplace. The illustrated embodiment includes a plurality of program modules: product qualification module 16, inventory qualification module 18, scheduler module 20, product data module 21, bidder module 22 and backend administration module 23. These modules are executable on a programmed data processor, such as the auction central processing unit 12. The central processing unit 12 typically includes one or more computers, servers, and the like, running a compatible operating system. Storage for the system may comprise hard disk drives, although other storage methods may be employed. Various data files and program modules reside on the hard disk drives and are central to operation of the system. The auction central processing unit 12 utilizes the various modules to execute the sale process module 25, explained more fully below.

An on demand auction is created according to the present invention when certain limits are met for a qualified product and a qualified inventory. That is, a predetermined minimum level of interest from potential bidders must be met to render a product “qualified” and a predetermined minimum number of qualified products must be met to render and an auction “qualified”. These determinations are made in the product qualification module 16 and inventory qualification module 18.

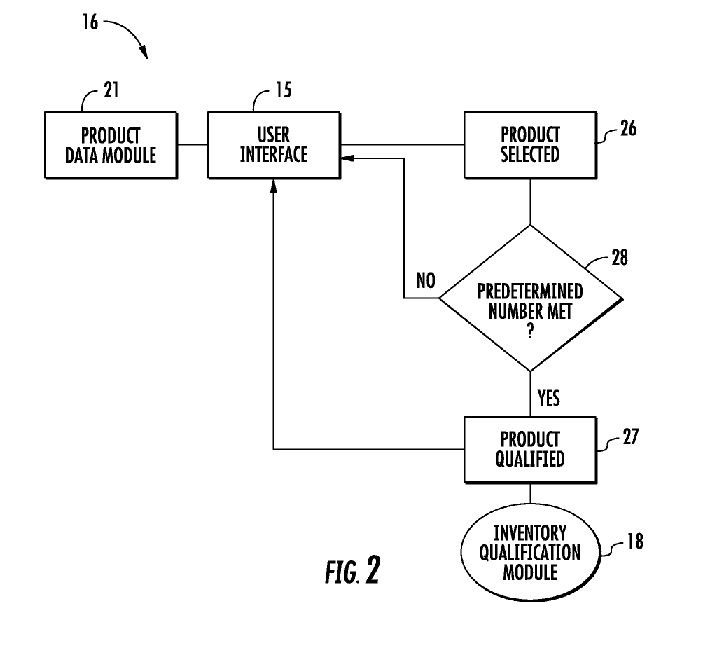

The product qualification module 16 is schematically represented in FIG. 2. This module represents the process for qualifying a product for auction. A product is qualified if a predetermined minimum number of bidders have indicated interest in bidding on the product. This predetermined minimum number is programmed by the backend administration module 23 and interpreted by the central processing unit 12. The user/bidder accesses the product data module 21 through the user interface 15 and previews available products, such as automobiles. If the user is interested in one or more automobiles, e.g., the user may select the desired product(s) at step 26. The central processing unit receives this information, represented by decision 28, and determines whether the addition of another bidder for each selected product satisfies or exceeds the minimum predetermined number of bidders previously set in the backend administration 23. If the addition of another bidder meets or exceeds the predetermined number, the product is qualified at step 27. If not, the central processing unit maintains the bidder's selection until the predetermined minimum number is met and notification of same will be sent to the user as explained more fully below.

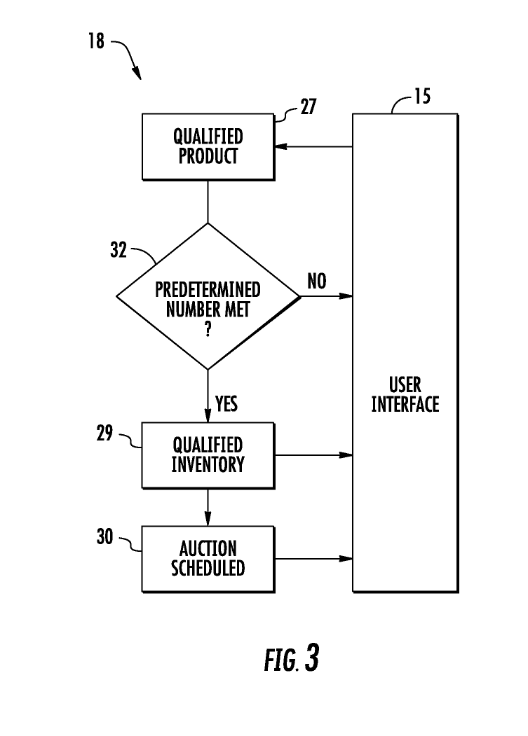

FIG. 3 is a schematic representation of the auction qualification module 18. Once a product 27 is qualified (from the product qualification module), the inventory qualification module 18 and the auction central processing unit 12 determine whether an inventory has been qualified. This occurs when a predetermined minimum number of qualified products 27, defined in the backend administration module 23, and represented by step 32 are present wherein an auction may be scheduled. More specifically, upon the addition of a first or subsequent qualified product 27, the central processing unit receives information of another unit which is compared, represented by decision 32, to a predetermined minimum number. If this number is met or exceeded, the information is relayed, by the central processing unit 12, an inventory is qualified at step 29, and an auction is scheduled at step 30. The information representing the details of the auction, e.g., the date and time, are sent to the user via the user interface 15. If the predetermined number of qualified products is not met, the user is also notified accordingly, and the central processing unit 12 stores this information until the predetermined number is met. Until such time, the auction is not scheduled. When the predetermined number of qualified products is met, subsequent bidders will receive an updated notification that the auction has been scheduled as will be explained in more detail below.

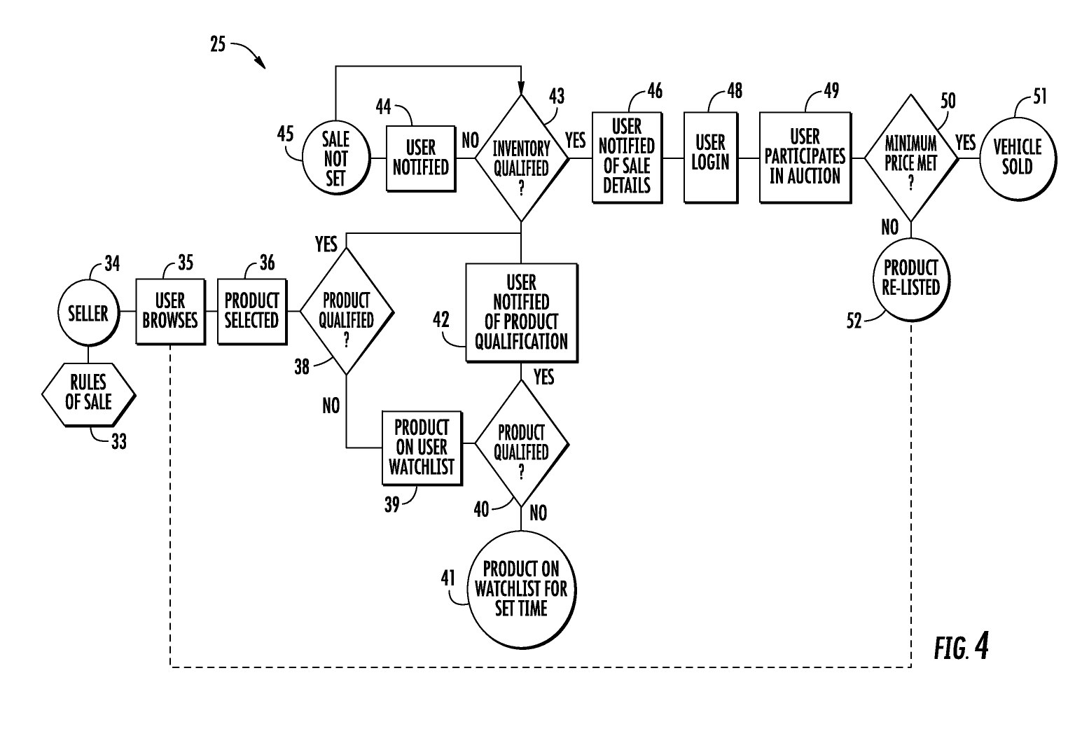

The sales process will now be described more fully in detail with reference to FIG. 4. FIG. 4 depicts the process flow chart of an on demand, buyer driven electronic auction, such as for automobiles. Initially, parameters are defined in the backend administration module 23. These include the predetermined number of bidders which must be interested in a particular product to qualify that product, and the predetermined number of qualified products needed to qualify an inventory for auction. These predetermined minimum thresholds are configurable by the system administrator and may be altered either automatically or by the administrator for particular products, when certain conditions are met, for example. It should be apparent, however, that the predetermined number of products may be set as one, meaning that every qualified product constitutes a qualified inventory and such variation is not a departure from the scope of the present invention.

The backend administration module 23 may also include numerous other configurable parameters and operations. For example, the module 23 preferably also includes security provisions such as for authentication and or verification of sellers and bidders. According to one embodiment of the present invention, only authorized sellers and bidders are permitted access to the electronic marketplace. For example, a login may be required to bid on a product or to promote a product and such login feature may be maintained, for example, through secured sockets through ssl sockets, or the like to the fire wall secured server.

The system 10 identifies the product available for sale at step 34 and provides the product data represented by the product data module 24 explained more fully below. The seller/consignor and/or the system operator may also define the minimum sales value for the product offered at step 34. The user browses the inventory of products (qualified or not) available as represented by step 35. The bidder may identify product(s) he or she is interested by selecting the appropriate button, explained more fully below, represented by step 36. The determination is made, at query step 38, whether or not the product is qualified. That is, whether or not the predetermined minimum number of bidders, previously defined in the backend administration step 33, has been met or exceeded. If it has not, the product is preferably placed on the bidder's watch list at step 39 (via user interface 15) and monitored (via the auction central processing unit 12) for additional interest. If additional bidder interest is identified, subsequent product qualification analysis is completed at step 40. If a sufficient number of bidders have not identified interest in a particular product, it is not qualified, and the product is removed from the bidder watch list, represented by step 41, after a predetermined amount of time has passed. Preferably, this predetermined amount of time is also defined in the backend administration step 33.

If the product selected by the bidder is immediately qualified as a product at step 38 or thereafter qualified at step 40, the central processing unit 12 and the inventory qualification module 18 determine if an auction is qualified. The query step 43 represents the determination of whether or not the predetermined number (identified in the backend administration step 33) of qualified products has been met or exceeded. If it has not been met or exceeded, the bidder is notified at step 44 that an auction has not yet been scheduled and the product awaits other bidders to identify interest in the product. When an additional buyer identifies interest, a subsequent inventory qualification query step 43 evaluates whether an inventory is qualified. If not, the sale is not set (step 45) and this cycle repeats.

If an inventory is qualified at step 43, the bidder is notified, at step 46, of the product and inventory qualification and is provided information regarding the auction. The bidder, at step 48, logs in to participate in the scheduled auction by signing into the auction at least by the assigned time. Step 49 represents the bidder participating in an auction wherein the bidder may simultaneously bid on the various qualified products 27 of the qualified inventory 29. Step 50 queries whether or not the minimum sales price, previously defined in the backend administration step 33, is met or exceeded. If so, the vehicle is sold at step 51 and backend processing begins. If not, the product is re-listed at step 52.

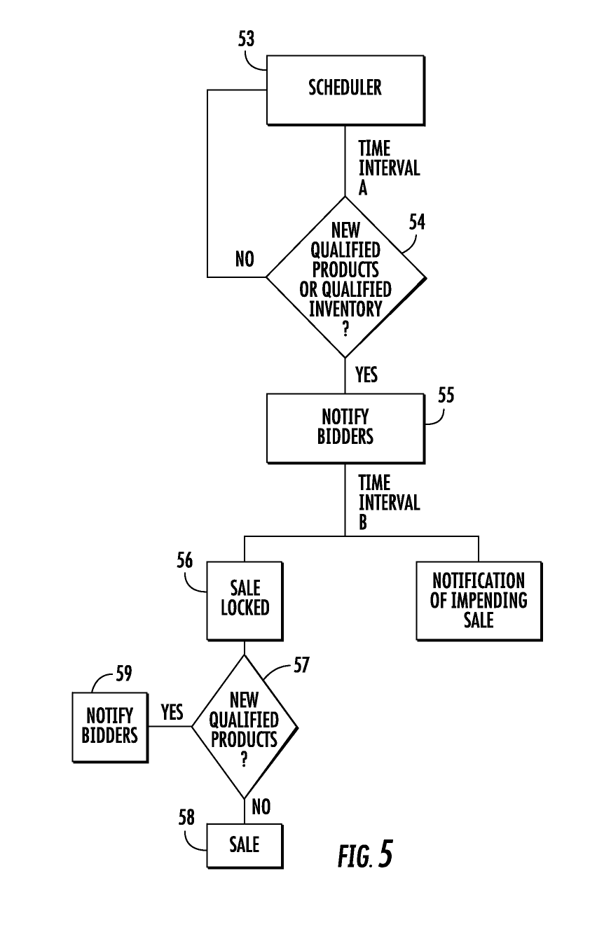

The scheduler module 20 is schematically represented in FIG. 5. The scheduler module monitors the products qualified and inventories qualified and, through the central processing unit 12, network 14, and user interface 15 runs the various jobs involved in the sales process. Various time intervals will be defined and configured by the system operator in the backend administration module 23. Preferably, these intervals are readily configurable by the system operator. FIG. 5 represents the scheduling that occurs once the inventory for an auction has been verified.

A sale is set by the scheduler at step 53 once an inventory is qualified. The scheduler 53 continuously runs specified jobs. A first time interval A represents the frequency in which the system runs a job to determine, at step 54, if there is a qualified product and, subsequently, a qualified inventory (or additionally qualified products to a previously qualified inventory) so as to set the sale as soon as possible. Additionally, this provides sufficient time to notify bidders in advance of the sale. The sale scheduler 53 is continuously determining, at time interval A, represented by step 54, whether a sufficient number of qualified products render an inventory qualified to schedule a sale and determines the qualified inventory. For example, the time interval A may be thirty minutes. Time interval A may be readily adjusted during peak usage or peak auction time windows so that the product qualification module and inventory qualification module are executed more regularly. For example, time interval A may be set so that the scheduler executes the job every 3 minutes or, in some cases, every 3 seconds.

Bidders of newly qualified products and bidders of products previously qualified as inventory are notified of the date and time of the sale at step 55. If a second time interval B representing a predetermined amount of time prior to the sale time is, for example, five minutes, then all bidders of any product in the qualified inventory of the sale are notified, such as be an email notification. Time Interval B is configurable and may be altered such, e.g., according to the level of interest from potential bidders. In some instances, such as with very high demand, the lock time may be extended and in periods of little demand, the lock time may be shortened. Time intervals A or B may also be adjusted in situations wherein products are one bidder away from being qualified perhaps even for an already qualified inventory set for sale. At this time, the sale is locked at step 56. At least once, and perhaps more times, during the lock time, the scheduler determines if additional products have become qualified at step 57 since the lock time. Newly added and eligible bidders are notified at step 59 as explained in detail below. The resulting sale is represented by step 58.

To illustrate the process, the present invention will be described in detail with exemplary predetermined parameters and time intervals defined in the backend administration module 23. It is to be understood, however, that these parameters and time intervals are provided for the sake of discussion and may be varied and remain within the scope of the presently claimed invention. For example, the time interval A set for the scheduler 53 may be thirty minutes wherein the scheduler job will run cyclically every thirty minutes to determine when a qualified inventory exists or additional qualified product(s) for a previously qualified inventory. Say, for example, that the predetermined minimum number of bidders required for a product to become qualified is four and the predetermined minimum number of products to constitute a qualified inventory is six. Say also, that the time interval B is five minutes wherein the sale is locked at five minutes before the set sale time. It is to be understood that these parameters are set in the backend administration module 23. Accordingly, the scheduler continues running every thirty minutes to determine if additional products should be part of a qualified inventory or if an initial inventory is qualified. As soon as the parameters are met, the scheduler sets a sale and displays the relevant information. For example, it might display the qualified inventory in the following format: “Consignor name-Auction-Day-Time”. Additionally, the bidders are notified of the sale, such as by email notification, which may include the following format: “Seller Name-Sale Name on [Date] at [Time]”.

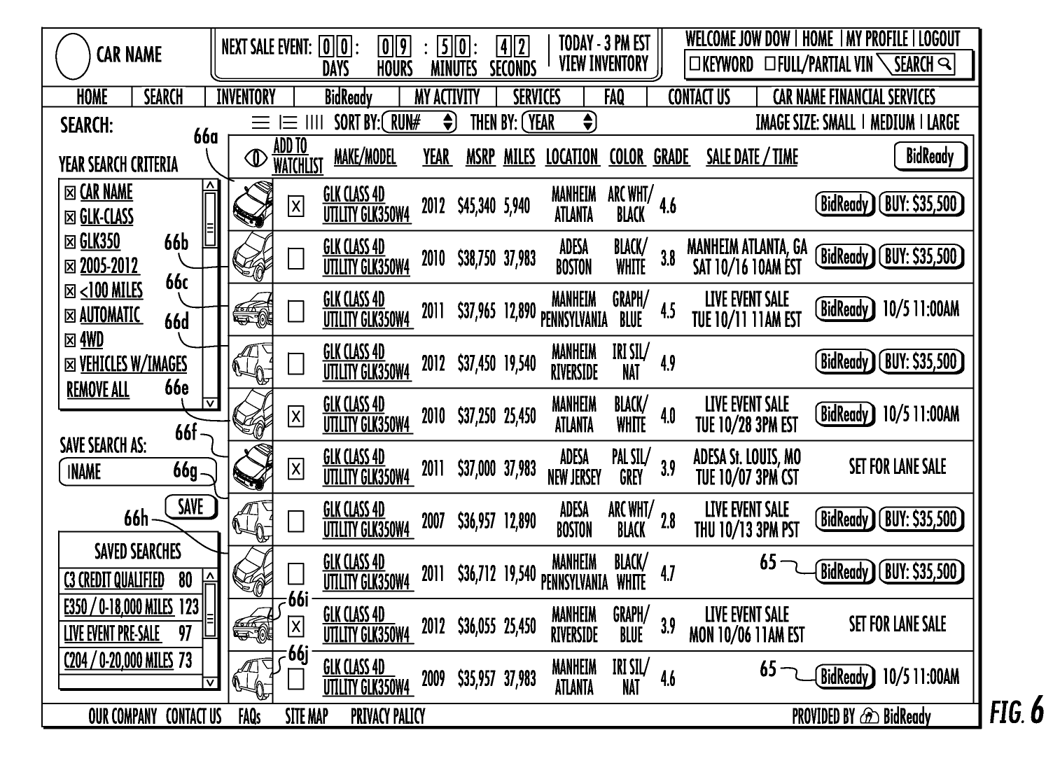

FIG. 6 is an exemplary screen shot of products offered for sale and which are eligible for a qualified inventory. The data in FIG. 6 may be of various formats and the one shown is by way of example only. The data shown are the result of a search conducted by the logged-in user. The screenshot of FIG. 6 incorporates data from the product data module 21. As shown in FIG. 6, a “buy now” price may also be provided. The product data module 21 may also be used to provide information about products that are being sold at a physical auction site and provides a medium in which to display all products offered at various auction sites—electronic and physical.

If the user indicates, by operation of buttons 65, that it will be a bidder on the product in an auction, then the bidder will receive one of the following email notifications. If the product has become, by the addition of the user or has previously become, part of a qualified inventory, the user may receive the following message: “Congratulations [User Name], you are ready for the auction. You can purchase this vehicle on our next sale at HH:MM AM/PM ET.” If the product is not yet qualified, the user may receive the following message: “Thank you, [User Name] for your interest in purchasing this vehicle. Once X more bidders choose to place this vehicle in the next sale, you will be notified.” A color coded system may also be employed. Referring to the example shown in FIG. 6, vehicles that are part of a qualified inventory wherein an auction has been set may have a button that has been changed to green, for example. The buttons 65 of lines 66 c, e and j would therefore be green in the example shown. Buttons 65 for vehicles that are in need of additional bidders may be a different color, say blue. The buttons 65 of lines 66 a, b, d, f, and g would, therefore, be blue. The buttons 65 may also be greyed out for users that have selected the product. During an electronic sale, the button 65 and “buy now” button for products in the sale will not be active.

By way of example, the following table is provided for the sake of discussion. It is not intended to limit the scope of the invention described herein. The following parameters are set in the backend administration module 23: the number of bidders required to qualify a product is at least four and the number of qualified products to qualify an inventory is at least six.

TABLE I
V = Vehicle and D = User

V1 has been activated by D1, D2, D3, D4, D5 and D6
V2 has been activated by D2, D3, D4, D5 and D6
V3 has been activated by D4, D5, D6 and D7
V4 has been activated by D9 and D5, D4
V5 has been activated by D8, D7, D4, D5 and D6
V6 has been activated by D8, D2, D10, D11 and D12
V7 has been activated by D1, D2, D5, D6 and D12
V8 has been activated by D6 and D11
V9 has been activated by D14 and D12
V10 has been activated by D15, D16 and D18

As soon as the sixth vehicle from the list V1-V10 has been activated/selected by four bidders, the product will become the sixth vehicle of the qualified inventory and a sale will be set as described above. In the example above, vehicles V1, V2, V3, V5, V6 and V7 have rendered the inventory qualified. Accordingly, users D1, D2, D3, D4, D5, D6, D7, D8, D11 and D12 will receive notification, such as by email, as soon as the sale is set by the scheduler. The notification may read as follows:
Congratulations [User name], vehicles you selected are now eligible for Sale. We have scheduled a sale on [Date] at [Time] EDT. Please make sure that you join the Sale [Sale Name] on [Date] at [Time] EDT.
You will be receiving an email for vehicle listing once the sale is finalized.
   Users D9, D14, D15, D17, and D18 will not receive the notification of a sale because the vehicles they activated/selected were not products of the qualified inventory.

As described above, the scheduler runs a status check at time interval A, e.g., thirty minutes in the example given, to determine whether new products have become qualified for a previously qualified inventory or if a new qualified inventory is attained. The scheduler 53 and, thus, the central processing unit 12, also manage delivery of email notifications throughout the sales process. This includes identifying new users that have selected a product that is now part of a qualified inventory and notifying those users while recognizing users that have already been notified. (This includes products that have become qualified during the lock time.)

Utilizing the example above, at the time the inventory was qualified vehicles V4 and V10 had the following status:
V4 has been activated by D9 and D5, D4; and
V10 has been activated by D15, D16 and D18.
After the sale was set by the scheduler, but before the lock time, the following occurred with respect to Vehicles V4, V10, V11 and V12:
V4 has been activated by D9, D5, and D4 when the sale was set and was subsequently activated by D3;
V10 has been activated by D15, D16, and D18 when the sale was set and was subsequently activated by D19;
V11 is a newly consigned product and has been activated by D20, D21, D22 and D23 after the sale was set; and
V12 is a newly consigned product and has been activated by D4, D5, D3, D16 and D9 after the sale was set.

The scheduler, via the central processing unit, network and user interface, notifies the users, such as by email, who have not previously received notification of the sale. This includes, in the example provided, D9, D15, D16, D18, D19, D20, D21, D22, and D23. As such, the scheduler runs simultaneous jobs, including identifying qualified inventories, notifying users so as not to send duplicative notifications, and monitoring the lock period. As to selection of products during the lock time, this is described below.

The scheduler 53, via the central processing unit 12, network 14 and user interface 15, also runs the job of finalizing the identity of the qualified products which are part of the qualified inventory ready for sale. At a predetermined time prior to the set sale date and time, a lockout period occurs. This enables the scheduler to identify the qualified products that will be sold and associate those product to the sale. The scheduler then sends an email notification to the bidders of products in the sale and provides a final list of the qualified inventory. The sale sequence, that is the order in which the products are listed, may be duplicative of the order in which the products were qualified. Such email notification may, by way of example, include the following information obtained from the product data module:

Congratulations [User Name], vehicles you selected are now eligible for sale. We have scheduled a sale on [Date] at [Time] EDT. Please make sure that you join the [Sale Name] on [Date] at [Time] EDT.
Below is the list of vehicles that are part of the sale today.

| Vehicle Sequence # | VIN | Make | Model | Trim | Mileage | Bid Amount | #Bidders |
|---|---|---|---|---|---|---|---|
| # 1 | WDBRSHLSG123131 | Mercedes Benz | C300 | W | 23,000 miles | $ | 8 |
| # 2 | WDBRX2230234231 | Mercedes Benz | C300 | W | 12,000 miles | $ | 6 |
| # 3 | WDBRX2230231422 | Mercedes Benz | C300 | W | 15,000 miles | $ | 5 |
| # 4 | WDBRX2230245334 | Mercedes Benz | C300 | W | 13,000 miles | $ | 12 |
| 5 | WDBRX2230231536 | Mercedes Benz | C300 | W | 19,000 miles | $ | 9 |
| # 6 | WDBRX2230234254 | Mercedes Benz | C300 | W | 11,000 miles | $ | 5 |
| # 7 | WDBRX2230231421 | Mercedes Benz | C300 | W | 15,000 miles | $ | 9 |
| # 8 | WDBRX2230231412 | Mercedes Benz | C300 | W | 19,000 miles | $ | 8 |

The scheduler, via the central processing unit, network and user interface, is also responsible for monitoring any vehicles that were not qualified prior the lockout period but which may have become qualified during the lockout period by eligible bidders subsequently selecting the vehicle. This applies to products that, e.g., are one bidder away from being qualified and a qualified inventory already is present and a sale is set. For example, assume V24 had been activated by D25, D14 and D4 and the vehicle did not become eligible for sale since it did not receive the minimum predetermined number of four bidders. For users D1 or D2 this vehicle will show in “1 Bidder Away Section” on their respective login screen described below. If the user D1 selects this vehicle, the system will determine if the following condition is met before making the qualifying the vehicle for the current (rather than for a future sale). The system checks if all the dealers who have activated the product are currently logged on and are in the system. If D25, D14 and D4 are shown logged onto the website and have not logged off or closed the browser, then the system will move the vehicle V24 to Sale and show vehicle V24 as Sale Vehicle and the next available sequence number will be shown. An email notification, sent by the scheduler, will be sent to dealers D25, D14, D4 and D1 or D2 who have activated the product with the note, for example:

The vehicle you had selected now became eligible for the current sale and it will be active and ready to receive bids in the current sale “[Consignor Name-Sale Name] Sale on [Date] at [Time] EDT”.

| Vehicle Sequence # | VIN | Make | Model | Trim | Mileage | Bid Amount | #Bidders |
|---|---|---|---|---|---|---|---|
| # 10 | WDBRSHLSG124344 | Mercedes Benz | C300 | W | 23,000 miles | $ | 4 |

If any of the relevant users are not logged into the website, the scheduler does not designate the vehicle to the current sale. The vehicle is held for a future sale. An email notification will be sent to users D25, D14, D4 and D1 or D2 (whoever activated the relevant product) from the scheduler the following:
The vehicle you had selected now became eligible for the Bid Ready sale and it will be considered for the future sale. You will receive notification once the sale is setup.

| VIN | Make | Model | Trim | Mileage | Bid Amount | #Bidders |
|---|---|---|---|---|---|---|
| WDBRSHLSG124344 | Mercedes Benz | C300 | W | 23,000 miles | $ | 4 |

The scheduler (through the central processing unit, network and user interface) is also responsible for appropriately notifying the bidders of the upcoming sale. For example, a notification, similar to one above, may be sent at a predetermined time before the sale, for example, 15 minutes prior to the sale. The predetermined time will be set by the system operator in the backend administration module.

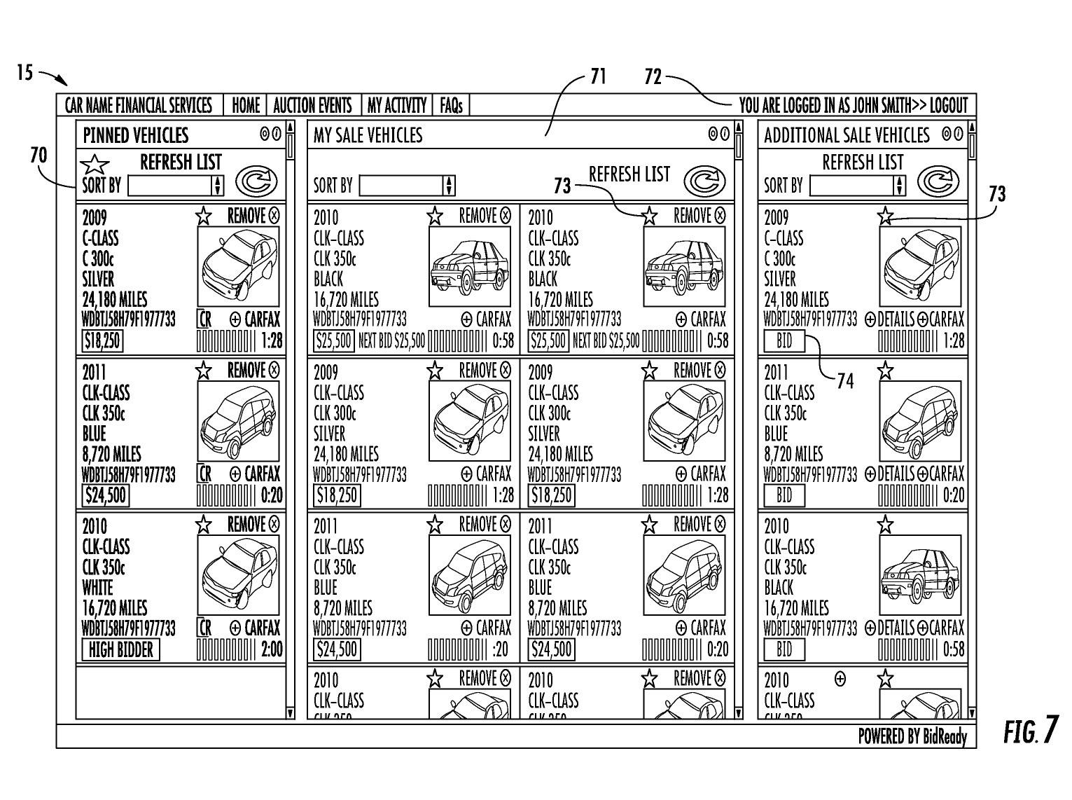

FIG. 7 is a representative screenshot of the user's display on the user interface 15 when the user is logged in and a sale is live as provided for in the bidder module 22. As shown, three columns are provided: Pinned Vehicles 70; My Sale Vehicles 71; Additional Sale Vehicles 72. The My Sale Vehicles column indicates the vehicles the user has activated with the button 65 on the product display screen shown in FIG. 6 and which products are part of a qualified inventory. The Additional Sale Vehicles 72 column list vehicles which are part of a qualified inventory but which have not been selected by the user. The Pinned Vehicles column includes vehicles for which the user has activated a button, such as star 73, in either the My Sale Vehicles 71 or Additional Sale Vehicles 72 columns If a product in the Pinned Vehicles column 70 has the star button 73 activated, it will be moved to the My Sale Vehicles 71 column, regardless of which column it originated. If a user bids on a product in the Additional Sales Vehicle 72 column, it will be moved to the My Sale Vehicles 71 column.

According to a preferred embodiment of the present invention, bid buttons 74 are provided. Vehicles for which bids have not been entered are displayed in the Additional Sale Vehicles column 72. Once the bid button 74 is activated, it moves the vehicle listing to the My Sale Vehicle 71 column. The current bid will, therefore, according to a preferred embodiment, be the minimum bid set by the consignor and entered in the backend administration module 23. Adjacent the bid button is cited the “next bid price”. This price is set in the backend administration module 23 and represents the predetermined incremental increase of each bid. The buttons 74 are preferable color coded. For example, the color blue may be used to indicate products that are currently being bid on and for which the user is not the current highest bidder. If the bidder is the current highest bidder, the button may turn a different color, e.g., green, and state that the user is the highest bidder. The user would preferably be precluded from raising a bid in which they are currently the highest bidder. A warning of a soon to be closing auction may be indicated as well, such as by the buttons 74 becoming red to indicate an imminent completion of the auction.

Refresh buttons may also be provided to reorder the products, such as in order of the time to close and/or the products for which the user is the highest bidder being reordered to the bottom. A remove button may also be provided, as shown in FIG. 7, to remove the product from sorting in any column and moving the product to the Additional Sale Vehicle 72 column. The remove button may be not being activated if the user is the highest bidder.

The following example is provided for the sake of discussion. Two users are logged in, D1 and D2, wherein D1 has activated V1 and V3 and D2 has active V2 and V4. The screen view for D1 (similar to FIG. 6) will depict V1 in the My Sale Vehicle 71 column and V2 in the Additional Sale Vehicles 72 column. The screen view for D2 will depict V2 in the My Sale Vehicle 71 column and V1 in the Additional Sale Vehicles 72 column.

A configurable sign-in page may also be provided. For example, when the user/bidder signs-in, such as prior to an auction, the page may display a My Sale Vehicles column, an Additional Sales Vehicles column, and a One Bid Away Vehicles column. The One Bid Away Vehicles column may encourage the user to activate the product in need of one more bid when the user sees the level of interest in the automobile. For example, assume six qualified products are needed and four bidders are needed for a qualified product. Assume the following: Vehicle V1 has been activated by D1, D2, D3, D4 and D5; V2 has been activated by D3, D4, D5, D6, and D7; V3 has been activated by D7, D8, D4, D3, and D2; V4 has been activated by D8, D4, D3, D2, and D1; V5 has been activated by D2, D8, D3, and D4; and V6 has been activated by D3, D4, and D5.

The Login screen for D1 will display the following:

My Sale Vehicles: V1, V4, V5

Additional Sales Vehicles: V2, V3

One Bid Away Vehicles: V6

The Login screen for D2 will display the following:

My Sale Vehicles: V1, V3, V4, V5

Additional Sales Vehicles: V2

One Bid Away Vehicles: V6

The Login screen for D6 will display the following:

My Sale Vehicles: V2

Additional Sales Vehicles: V1, V3, V4

One Bid Away Vehicles: V6

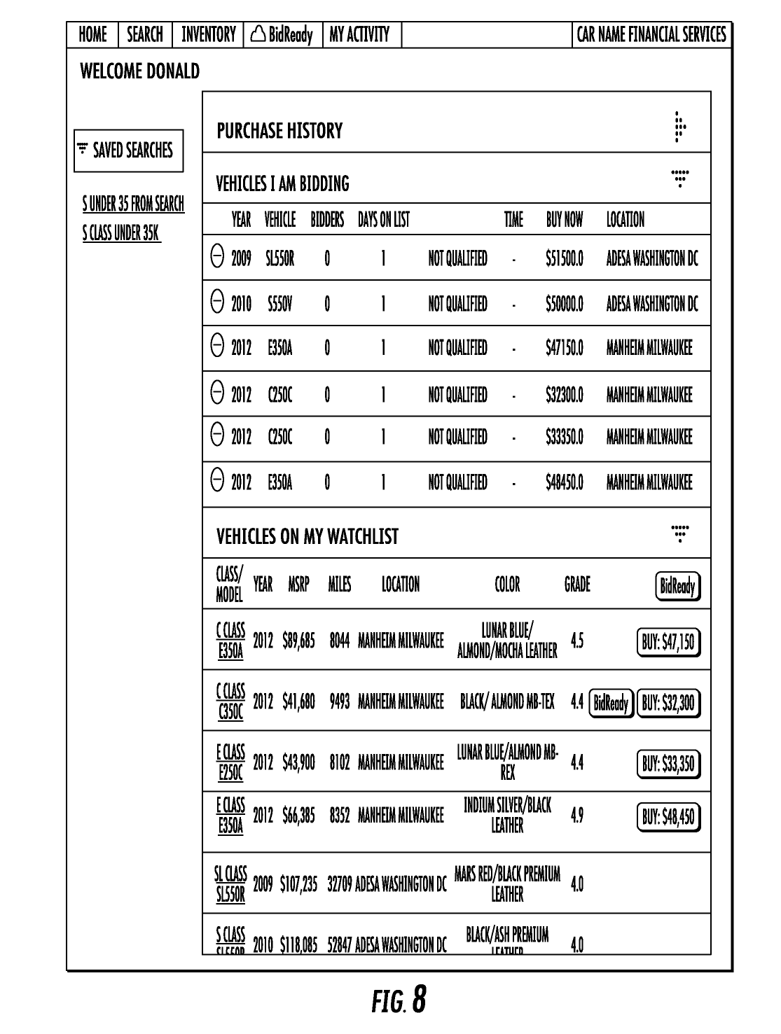

FIG. 8 is a screen shot of an exemplary login page which depicts information provided to the user on the login page. As shown, there is a column which indicates the number of bidders for a particular product, the number of days on the exemplary lists, and product information. Also shown is a product that is part of a qualified inventory.

As described herein, a system and method are provided and capable of handling an inventory of hundreds, thousands, or more of products and which run a variety of jobs simultaneously to execute the sales process. This is accomplished at a variety of remote locations, for auctions in multiple time zones and presented to hundreds, thousands, or more bidders simultaneously. The system is configurable to accommodate various circumstances, such as, demand levels, time parameters, and/or interest parameters, relevant to the product being sold.

In the drawings and the specification, there has been set forth preferred embodiments of the invention and, although specific terms are employed, the terms are used in a generic and descriptive sense only and not for the purpose of limitation, the scope of the invention being set forth in the following claims.

What is claimed is:

1. A computer-implemented method for conducting an on-demand, electronic auction for one or more qualified products in one or more qualified inventories wherein the method is implemented in a computer system when executed by at least one processor configured to execute one or more computer program modules, said method comprising:
(a) storing, on the at least one processor, a predetermined minimum number of product activations to constitute a qualified product and a predetermined minimum number of qualified products to constitute a qualified inventory;
(b) continuously evaluating whether the product is said qualified product:
(i) presenting a user, with a user interface, information for at least one product derived from a product data module;
(ii) providing the user, on the user interface, with an activation member for each of said at least one products, said activation member for indicating the user's interest in the product and for providing a first executable instruction to the at least one processor that the product has been activated;
(iii) receiving the instruction from the activation member that the product has been activated and evaluating an actual number of product activations;
(iv) comparing the actual number of product activations to the predetermined minimum number of product activations for determining whether the product is a qualified product;
(v) generating a second executable instruction to the processor for each of said qualified products;
(vi) generating a third executable instruction to the processor including the number of qualified products;
(c) continuously evaluating whether the one or more inventories is qualified;
(i) comparing the actual number of qualified products to the predetermined minimum number of qualified products;
(ii) generating a fourth executable instruction to the processor for each of said one or more inventory that is said qualified inventory;
(d) executing, on the processor, the second executable instruction of the qualified products and the third executable instruction of the qualified inventory;
(e) scheduling, on the processor, the auction for the qualified inventory; and
(f) conducting, on the processor with the user interface, the auction providing substantially simultaneous bidding on each of the one or more qualified products in the qualified inventory.

2. A method according to claim 1 wherein said electronic auction is for automobiles.

3. A method according to claim 1 wherein the step of continuously evaluating whether the product is a qualified product occurs at a first time interval and said step of continuously performing a determination of whether the inventory is qualified occurs at said first time interval.

4. A method according to claim 1 which comprises the step of notifying the user, through the user interface, of activated products which are not qualified products and further notifying the user when the activated product becomes said qualified product.

5. A method according to claim 4 which comprises the step of notifying the user, through the user interface, if the qualified product is within the qualified inventory.

6. A method according to claim 5 which comprises the step of notifying the user, through the user interface, of a start time for the on demand auction.

7. A method according to claim 4 which comprises the step of providing a watch list on the user interface for displaying a status of the activated products.

8. A method according to claim 1 which comprises a user authentication step for identifying the user and authorizing participation in the auction.

9. A method according to claim 1 wherein the scheduling step (e) includes sending an executable instruction to the processor setting a time of the auction and includes notifying users of the auction time.

10. A method according to claim 9 wherein the scheduling step comprises locking the sale for a first predetermined time after the notifying step and defining the qualified inventory wherein the method continues for one or more different qualified inventories.

11. A method according to claim 10 wherein during said locking step, the processor continuously evaluates interest in products which have become qualified products during the locking time.

12. A method according to claim 1 wherein at least two qualified products are in said qualified inventory and said step of conducting the auction includes providing said at least two products for substantially simultaneous bidding within the auction.

13. A method according to claim 12 wherein the step (f) of conducting the auction comprises said at least two qualified products auctioned at substantially the same time.

14. A method for conducting an on-demand auction, wherein the method is implemented by a computer system comprising at least one processor for executing one or more program modules stored in a computer-readable medium, the method comprising:
executing, on the at least one processor, a product data module configured for use with a user interface comprising:
presenting users of the method with at least one product;
providing an activation member for each of said at least one product wherein the user may activate said member to demonstrate interest in said at least one product; and
providing a computer readable instruction of the product activation to the at least one processor;
executing, on the at least one processor, a backend administration module configured to obtain a predetermined minimum number of activated products and a predetermined minimum number of qualified inventories;
executing, on the at least one processor, a product qualification module configured to receive said instruction from the product data module and configured to identify one or more qualified products, the executing step including evaluating said product data module instruction to determine if said predetermined minimum number of activation members have been activated and to provide a computer readable instruction to the processor regarding a determination of whether the at least one product is qualified;
executing, on the at least one processor, an inventory qualification module configured to receive said instructions from said product qualification module and being configured to identify at least one qualified inventory, the executing step including evaluating said instruction from said product qualification module to determine if said predetermined minimum number of qualified products is met and providing a computer readable instruction to the computer system when the inventory is qualified;
executing, on the at least one processor, a scheduler module configured to receive said instruction from said inventory qualification module and comprising:
providing a computer readable instruction to the computer system that an auction is scheduled;
identifying users eligible to participate in the scheduled auction;
identifying products of the qualified inventory;
notifying the users of the auction; and
executing, on the at least one processor, a bidder module for conducting an auction for bidding on the at least one product of the qualified inventory.

15. A method according to claim 14 wherein said electronic auction is for automobiles.

16. A method according to claim 14 wherein at least two qualified products are in said qualified inventory and said step of conducting the auction includes providing said at least two products for substantially simultaneous bidding within the auction.

17. A method according to claim 16 wherein said bidder module for conducting the auction comprises said at least two qualified products auctioned at substantially the same time.

18. A method according to claim 14 wherein said scheduler module includes sending an executable instruction to the processor setting a time of the auction and includes notifying users of the auction time.

19. A method according to claim 18 wherein said scheduler module further comprises locking the sale for a first predetermined time after the notifying step and defining the qualified inventory wherein the method continues for one or more different qualified inventories.

20. A method according to claim 14 wherein said backend administration module comprises a user authentication step for identifying the user and authorizing participation in the auction.

21. A system for receiving one or more product activations indicative of interest in at least one product and for conducting an on demand auction comprising at least one processor unit and a user interface and further comprises:
(a) a backend administration application for storing, on the at least one processor, a predetermined minimum number of product activations to constitute a qualified product and a predetermined minimum number of qualified products to constitute a qualified inventory;
(b) a product qualification application for continuously evaluating, at a first time interval, interest in the product and which comprises:
(i) presenting a user with product information for each of said at least one products;
(ii) providing the user with an activation member for each of the products to indicate interest in the products by generating a first executable activation instruction;
(iii) receiving the activation instruction from the activation member;
(iv) evaluating the number of activation instructions by comparing to the predetermined minimum number of product activations for determining whether the product is said qualified product;
(v) generating a second executable instruction to the processor identifying a number said at least one product that is said qualified product;
(vi) generating a third executable instruction to the processor of the number of qualified products.
(c) an inventory qualification application for continuously performing a determination of whether the inventory is qualified and which comprises:
(i) comparing the number of qualified products to the predetermined minimum number of qualified products to constitute a qualified inventory;
(ii) generating a third executable instruction to the processor for each inventory that is said qualified inventory;
(c) a scheduler application for executing, on the processor, the second executable instruction of the qualified product and the third executable instruction of the qualified inventory and scheduling, on the processor, the auction for the qualified inventory; and
(d) an auction application for receiving instructions from the scheduler application and for conducting the auction which comprises:
(i) identifying eligible participants of the auction;
(ii) identifying a length of time for the auction;
(iii) presenting the qualified inventory to the eligible participants through the user interface;
(iv) providing a bidding member on the user interface for the one or more qualified inventories, said bidding member for generating a bid instruction to the at least one processor;
(v) simultaneously enabling the participants to bid on the one or more products of the qualified inventory;
(vi) receiving the bid instruction and identifying winning bid upon completion of the auction time.

22. A system according to claim 21 wherein said at least one product is at least one automobile.
